(19) United States
(12) Patent Application Publication
(10) Pub. No.: US 2025/0225963 A1
(43) Pub. Date: Jul. 10, 2025

(54) Electronic Keyboard with Selectable Diatonic and Jazz Scales

(71) Applicant: Allyn MELVARD Shell, Silver Spring, MD (US)

(72) Inventor: Allyn MELVARD Shell, Silver Spring, MD (US)

(21) Appl. No.: 19/095,848

(22) Filed: Mar. 31, 2025

Related U.S. Application Data
(63) Continuation-in-part of application No. 18/047,542, filed on Oct. 18, 2022.

(51) Int. Cl. G10H 1/00; G10H 1/18; G10H 1/34; G10H 1/38

(52) U.S. Cl. CPC G10H 1/0025; G10H 1/18; G10H 1/344; G10H 1/383

(57) ABSTRACT

This patent is about special scale configurations for electronic keyboards and controls to select them. Currently most keyboards are tuned to a well-tempered chromatic scale. This patent presents several alternate scales which can be selected by the musician. These selectable scales include the major and minor diatonic basic and active scales, major and minor semi-diatonic basic and active scales, jazz basic and active scales among others. This patent extends to an electronic component for studio use that incorporates automatic chord recognition and alternate scale selection to produce more harmonious pitches for notes played on a keyboard. This patent also describes reed instruments such as the melodica and the accordion when capability to select alternate scales is added.

### CROSS-REFERENCE TO RELATED APPLICATION

This application is a Continuation in Part of application Ser. No. : 18/047,542 originally submitted on Oct. 18, 2022.

### STATEMENT REGARDING PRIOR DISCLOSURES

This Continuation in Part is closely related to application Ser. No. : 18/047,542. It contains many of the same claims. The background is simpler and slightly more understandable than the original application's background. The detailed description of the invention is more complete especially regarding the active scale selector variable and the chord recognition feature.

### BACKGROUND OF THE INVENTION

This invention is primarily about scales for an electronic keyboard, alternate scale pitches and controls to use them. The following sections describe several types of musical scales and how they differ in the pitches assigned to the notes within the scales.

### PRIOR ART

Electronic keyboards have become very common. Some keyboards are built with a full eight octave set of keys that look exactly like the keys on a piano. The piano makes its sound by a mechanical mechanism that directly strikes strings, but an electronic keyboard makes its sound electronically.

The components of an electronic keyboard may all be part of one device (a Stage Keyboard), or they can be spread out across multiple devices. Most obvious is the means for producing musical sounds. A Stage Keyboard has a built-in sound module and to built-in speakers. The audio signal produced by the keyboard's sound module can be sent directly to the built-in speakers. But, the same keyboard may also have an output to send the audio signal to an external amplifier or a sound board which then sends the amplified signal to a set of external speakers.

In a studio, a MIDI Keyboard may send a sequence of MIDI signals to a Digital Audio Workstation (DAW) where it can be stored in memory for later manipulation by a producer. The DAW has a sound module that can convert the MIDI signal into an audio signal and sends it to a speaker in the DAW for the producer to hear. Therefore the term “electronic keyboard” could represent a system of electronic devices which collectively comprise all the means described herein. Even the scale selection controls could be under the control of the producer rather than the musician playing the keyboard.

Keyboards can be made to associate their keys with different kinds of sounds, like different instruments or the wind or an animal. This is accomplished by the sound module, and it is controlled simply by selecting the sound using a device on the control panel of the keyboard. Other controls allow the keyboard to transpose the notes being played into different keys, although the scales being played are usually all based on the well-tempered chromatic scale. Other controls might be added to allow all the notes on the keyboard to be tuned to a different pitch or to “bend” the pitch for effect like some guitars. The application of these types of electronic pitch production and their controls is a well-developed art.

In addition to hand operated controls on a built-in control panel, most keyboards also incorporate foot controls like a piano sustain pedal. Some keyboards have a volume control that is built like the accelerator pedal in a car. Other foot controls have been added similar to the foot controls for a guitar. These foot controls allow the musician to change settings while continuing to use his or her hands for operating the keyboard keys to make music.

### FEATURES SUPPORTING THE INVENTION

### Summary of Harmonic Intervals

The frequency of all the tones of a diatonic scale are exact multiples of a fundamental frequency. When a harmonic interval is referenced in this disclosure the frequency of the higher pitch is presented first and the frequency of the lower pitch is presented second after a ‘/’. (This representation is sometimes called a frequency ratio.) For instance, a harmonic interval of 2/1 is an octave. This harmonic interval is special because both the higher and lower frequencies are given the same name. The smaller the numbers of a harmonic interval, the more harmonious that interval sounds.

The harmonic intervals that will be discussed in this disclosure are:

| | |
|---|---|
| 2/1 | the octave, |
| 3/2 | the fifth, |
| 4/3 | the fourth, |
| 5/4 | the major third, |
| 6/5 | the minor third, |
| 7/6 | the long jazz seventh step, |
| 8/7 | the short jazz seventh step, |
| 9/8 | the long whole step, |
| 10/9 | the short whole step, |
| 16/15 | the half step and |
| 81/80 | the syntonic comma. |

Since music pitches are logarithmic, to build a larger interval by “adding” two smaller intervals, mathematically we must multiply the frequency ratio numbers together. For instance the interval created by “adding” a fourth to a fifth is: 4/3 * 3/2=>4/2=2/1, an octave. And, “adding” a major third to a minor third is: 5/4 * 6/5=>6/4=3/2 a fifth. Therefore, the “sum” of a major third, a minor third and a fourth, which form the major chord, is an octave.

### Summary of the Well-Tempered Scale Theory

The well-tempered chromatic scale contains twelve identical half step intervals. The half step interval of the well-tempered chromatic scale has an interval that equals the twelfth root of two. So when you “add” twelve of these well-tempered half steps together you get back the octave interval of 2/1. The whole-step interval of the well-tempered chromatic scale is two well-tempered half-steps “added” together. A well-tempered major scale contains notes separated by: two whole steps, a half step, three whole steps and another half step. A minor scale starts on the sixth note of its relative major scale.

During the Classical Music era in Europe, the well-tempered scale was perfected, and ever since pianos and keyboards have been tuned to a well-tempered chromatic scale which contains twelve half steps. This tuning allows all keys to sound reasonably in tune without changing any notes. Even when the modern sound modules such as Auto-Tune do pitch correction, they shift the pitch to the nearest chromatic half step of a well-tempered chromatic scale. This is done with real-time pitch recognition which is a well-developed art.

### Summary of Diatonic Scale Theory

Using the harmonic intervals described above in the Summary of Harmonic Intervals subsection, we can construct a diatonic scale that is much more harmonious than a well-tempered scale.

The well-tempered major scale is the most common scale in western music. It contains 7 notes (8 counting the octave of the tonic). If we number the notes of this scale from 1 to 8, then this scale is (scale note numbers) 1->2 whole step, 2->3 whole step, 3->4 half step, 4->5 whole step, 5->6 whole step, 6->7 whole step and 7->8 half step. Notes 1 and 8 form the 2/1 harmonic interval of an octave (even when the tuning used is the well-tempered chromatic tuning). But the notes using the other intervals cannot be exactly aligned with the well-tempered chromatic notes. In most cases a harmonic interval lands on pitches that are close to a well-tempered chromatic note.

The Fifth is the first diatonic pitch that we will examine. It is very close to the interval of seven chromatic half steps. The diatonic fifth falls exactly on the third harmonic of the fundamental when that fundamental is the tonic of the diatonic scale. The Fifth is about 2 percent of a chromatic half step above the corresponding well-tempered note. (NOTE: All offsets from a chromatic half step are herein given to the nearest whole percent. In music theory each percent of a chromatic half step is called a cent. So I will use the ¢ symbol.) So the diatonic fifth is 2¢ above its corresponding well-tempered note.

The Fourth is next. It is the complement to the Fifth. (If you “add” a fourth and a fifth, you get an octave.) The Fourth is very close to five chromatic half steps. It is only 2¢ below the corresponding well-tempered note (or −2¢). But, the Fourth does not fall on a harmonic of the tonic of the diatonic scale. Rather, the tonic of the diatonic scale falls on the third harmonic of a fundamental that is on the Fourth of the diatonic scale. That renumbers the octaves of the tonic to fall on harmonics 3, 6, 12, 24, 48 etc. When the Fourth is the fundamental, the Tonic, Fourth and Fifth will fall on harmonics 6, 8 and 9 respectively.

The Tonic, Fourth and Fifth are the three notes of the diatonic scale that have major chords within the diatonic scale. A major chord includes the notes that are at intervals of a major third and a fifth above the tonic of the chord. The major third interval is −14¢ short of four well-tempered chromatic half steps. That makes the third of the diatonic scale −14¢ below the corresponding well-tempered note. The sixth note of the diatonic scale is the major third of the Fourth chord which places it at −16¢ below the corresponding well-tempered note. The seventh note of the diatonic scale is the major third of the Fifth chord which places it at −12¢ below the corresponding well-tempered note. The second of the diatonic scale is the fifth of the Fifth chord which places it at 4¢ above the corresponding well-tempered note.

A major chord starting on note 4 includes scale notes 4, 6 and 8 (which is the octave of note 1). A major chord starting on note 1 includes notes 1, 3 and 5. A major chord starting on note 5 includes notes 5, 7 and 9 (which is the octave of note 2). Putting these notes in order gives us the diatonic scale with a just tuning. The scale with the fundamental on the fourth in the octave with note 4 at harmonic 32, has all notes of the diatonic scale on simple harmonics of the fundamental pitch. That diatonic scale is composed of the notes that fall on harmonics 24, 27, 30, 32, 36, 40, 45 and 48. In the next octave the chromatic notes can be added: 48, (51), 54, (57), 60, 64, (68), 72, (76), 80, (85), 90, 96. This is the basic diatonic scale with all the chromatic notes added.

Comparing the well-tempered notes to the diatonic notes, the diatonic major scale notes are at: 0¢, +4¢, −14¢, −2¢, +2¢, −16¢, −12¢ and 0¢. The harmonic intervals between the notes of this scale are 9/8 the long whole step, 10/9 the short whole step, 16/15 the half step, 9/8 the long whole step, 10/9 the short whole step, 9/8 the long whole step and 16/15 the half step in that order.

Cumulatively the harmonic intervals from the tonic are (1/1,) 9/8, 5/4, 4/3, 3/2, 5/3, 15/8 and 2/1. Multiplying these values by the smallest common multiple of the denominators, 24, gives us the pitches for the diatonic scale 24, 27, 30, 32, 36, 40, 45 and 48 as shown above. This is the diatonic scale and it has a “just” tuning that is very harmonious sounding.

### Summary of Pentatonic Scale Theory

The pentatonic scale has only five notes in each octave (not counting the octave itself). These five notes are 1, 2, 3, 5 and 6 of the seven note diatonic scale. Diatonic notes 4 and 7 are not included. The interval from note 3 to note 5 is a minor third, and the interval from note 6 to note 1 (8) is a minor third. The interval from note 1 to note 5 is a fifth, and the interval from note 5 to note 2 (9) is also a fifth. So the notes of the pentatonic scale fall exactly on the harmonics of the corresponding notes of the diatonic scale. The harmonic intervals between the notes of this scale are 9/8, 10/9, 6/5, 10/9, 6/5. The only major chord is the tonic on the notes 1, 3 and 5. The only minor chord in the pentatonic scale is the relative minor of the tonic chord on 6, 1 and 3.

The major chords of the Fourth and Fifth and their relative minors are not available in this pentatonic scale. In order to include these chords, the pentatonic scale must be shifted to place the tonic of the pentatonic scale on the Fourth or Fifth of the scale with which it is associated.

Musicians who improvise often use the pentatonic scale as a base for their improvisation, and when the chord changes, they shift to the corresponding pentatonic scale. In the musician's mind the scale moves from 1, 2, 3-5, 6 to 2, 3-5, 6, 7. This change in the musician's mind appears to only move note 1 (8) down a half step to become 7. But the musician actually compensates by changing the pitch of note 6 a hair to keep the music harmonious. The new pentatonic scale has an interval between notes 2 and 6 of 3/2 which is a fifth. This is a change of 81/80 to note 6. The ratio of 81/80 is called a syntonic comma (the harmonious hair).

A similar change is made when the chord is changed to the Fourth. To the musician, note 3 is moved a half step to note 4, but note 2 is also changed a hair to remain harmonious. The new pentatonic scale is 1, 2-4, 5, 6. Exactly the same changes are made to the pentatonic scale for minor chords. When changing between a Fifth chord and a Fourth chord (or any combination that includes their relative minors), both diatonic notes 2 and 6 must be changed a hair.

Notably the changes to the pentatonic scale simply amounts to changing a long whole step to a short whole step (or visa-versa). The pentatonic scale is simply a set of whole steps separated by a minor third from another set of whole steps. Every set of whole steps in pentatonic scales always has a short whole step before the minor third when ascending.

### Summary of Active Scales

The changes made to the pentatonic scale when chords change should also be made to the diatonic scale in which the chords reside. As noted above, the harmonic intervals between the notes of the diatonic scale are 9/8, 10/9, 16/15, 9/8, 10/9, 9/8 and 16/15. That is: long whole step, short whole step, half step, long whole step, short whole step, long whole step, half step. This basic diatonic scale is the active scale when the major tonic chord (represented by ‘I’) or its relative minor chord (‘vi’) is played. (The Roman numerals refer to 50 in FIG. 5 the Tonnetz Chart for Chord Recognition where upper case is major and lower case is minor.)

As with the pentatonic scales, when the Fifth (‘V’) major chord or its relative minor chord (‘iii’) is used note 6 of the diatonic scale should shift up by a comma so the scale becomes: long whole step, short whole step, half step, long whole step, long whole step, short whole step, half step. This is the active scale for the Fifth of a diatonic scale.

Similarly, when the Fourth (‘IV’) major chord or its relative minor chord (‘ii’) is used note 2 of the diatonic scale should shift down by a comma so the scale becomes: short whole step, long whole step, half step, long whole step, short whole step, long whole step, half step. This is the active scale for the Fourth of a diatonic scale.

Therefore, the diatonic scale is actually three scales which should alternate being active as the chords change within a piece of music. Active scales can also be associated with other types of basic scales such as semi-diatonic scales that are simple extensions of a well-tempered chromatic scale for use in reed instruments such as the accordion, or jazz scales which have eight notes rather than seven notes per octave to include the seventh, eleventh and thirteenth harmonics. All of these special scales can have active scales. These active scales and the controls to manipulate them are the central theme of this invention.

### Summary of Semi-Diatonic Scale Theory

The diatonic scale in both its basic and active forms is made possible for an electronic keyboard by the use of an electronic sound module which generates the sound for whatever pitch is electronically specified. But, reed instruments such as the accordion can only produce sounds for the pitches produced by physical reeds built into the instrument. If such an instrument was able to produce a diatonic scale in any key, every note would need to have nine reeds to support the basic and active diatonic scale pitches of every key. But the introduction of reeds that follow a semi-diatonic scale only requires two reeds for each note.

This reduction is accomplished by noting that the comparison between a diatonic scale and a well-tempered chromatic scale come in groups of offsets that are: −2¢, 0¢, +2¢, and +4¢ or −12¢, −14¢ and −16¢. And, these groups correspond to the lower row and upper row of the Tonnetz chart of FIG. 2 respectively. By tuning the reeds for the notes of the lower row of the Tonnetz chart to the well-tempered chromatic scale, and the notes of the upper row of the Tonnetz chart to pitches that are −14¢ lower than the well-tempered chromatic scale, a semi-diatonic scale can be produced that is never more than 4¢ from the diatonic scale. This scale has the advantage that only two reeds per keyboard key are needed to cover all the pitches for every active scale in every key.

The accordion also has the advantage that the musician is designating the chords directly by pressing buttons on the panel opposite the keyboard of the accordion. These can control the choice of reeds for the active scales.

### Summary of Jazz Scale Theory

The diatonic scale has seven notes per octave, but the jazz scale has eight notes per octave. And, the jazz scale has the most beautiful note in all music. That note is missing from all the other scales. That note is the jazz seventh. Most people have only heard that note from wind chimes or Tommy Dorsey's theme song, “I'm Getting Sentimental Over You”. The jazz seventh is the note used by every “jazz nightclub” singer to end a song with a beautiful haunting sound.

If you follow the harmonics up from a fundamental pitch on the Tonic, all the jazz notes are on exact whole number multiples of the fundamental (which is always given the number 1). Every octave the harmonic number doubles, so the octaves of the fundamental are 1, 2, 4, 8, 16, 32, 64, etc. In the second octave (2 to 4) the Fifth appears at harmonic 3. The octaves of the Fifth are 3, 6, 12, 24, 48, etc. The next octave (4 to 8) introduces the major chord of the Tonic. The major chord is made possible by the introduction of harmonic 5, the major third of the tonic. The major chord of the Tonic falls on harmonics 4, 5, 6 and 8. The octaves of harmonic 5 are 5, 10, 20, 40, etc. Just as a fourth complements a fifth to form an octave, the minor third complements the major third to form a Fifth.

But the third octave (4 to 8) of the fundamental also contains harmonic 7. Its octaves are 7, 14, 28, 56, etc. The new harmonic notes in the fourth octave (8 to 16) are 9, 11, 13 and 15. Of these harmonics 9 and 15 are part of the diatonic scale, so only harmonics 11 and 13 are considered new jazz notes. In the next octave (16 to 32) the first two new harmonics 17 and 19 are technically jazz notes, but they are not usually considered jazz notes because they fall exactly on the half step notes of the diatonic scale. But it is interesting to observe that these five new jazz notes all fall on harmonics that are prime number harmonic multiples of the tonic: 7, 11, 13, 17 and 19.

FIG. 2 shows the jazz notes and the diatonic notes of the two octaves from harmonic 8 to harmonic 32. Ignoring the two extra jazz notes at the beginning of the first octave, the harmonics of the first octave are 8, 9, 10, 11, 12, 13, 14, 15 and 16. Two non-jazz diatonic pitches, the fourth and sixth, also appear in this octave. They correspond to 10 2/3 and 13 1/3 respectively. Remember the fundamental of the diatonic scale is the Fourth, so all the harmonics of the diatonic scale are multiples of 3 except the Fourth (32) and the sixth (40). If you multiplied all the harmonics (between 8 and 16) by 3 in FIG. 2, the first octave would go from harmonic 24 to harmonic 48 (ignoring the two extra jazz notes). The harmonics would skip two of every three harmonics: 24, 27, 30, 33, 36, 39, 42, 45 and 48. Then the added diatonic notes are 32 and 40.And the purely jazz notes are 33, 39 and 42 which are octaves of 11, 13 and 7 respectively.

Because there are exactly enough keyboard keys for all the diatonic notes, these three jazz notes and the two extra jazz notes that appear in the first octave of FIG. 2, these are the notes that should be mapped onto the keyboard keys to support the basic jazz scale. For example, for the C diatonic/jazz scale the white keyboard keys play the C diatonic scale. The basic eight note C jazz scale would correspond to the scale notes C, D, E, F #, G, Ab, Bb, B & C which occupy harmonics: 8, 9, 10, 11, 12, 13, 14, 15 & 16. If the notes are multiplied by 6 and the jazz scale and diatonic scale are over laid the result is: 48, (51), 54, (57), 60, 64, (66), 72, (78), 80, (84), 90, 96 (where the five jazz notes are in parentheses).

The eight note jazz scale does not lend itself to the pentatonic scale at all, so pentatonic scales do not apply at least not in the same way as for the purely diatonic scales. But the diatonic scale is present on the keyboard with the jazz scale. So the active scales for the diatonic part can act the same. But the jazz seventh, eleventh and thirteenth could be moved with active chord changes.

For the major fourth chord of the C scale, the note that should change is the Eb note. In the octave starting with harmonic 48, the b3 (flat third) note is harmonic 57 to change this to the jazz seventh, harmonic 56 should be used as part of the active scale. For the major fifth chord of the C scale, the note that should change is F (see FIG. 5). In the octave starting with harmonic 48, note 4 is harmonic 64 to change this to the jazz seventh, harmonic 63 should be used as part of the active scale.

I recommend that the basic and active jazz scales be given the harmonics as follows: for the basic jazz scale 48, (51), 54, (57), 60, 64, (66), 72, (78), 80, (84), 90, 96; And for the fourth's active jazz scale 48, (52), 53&1/3, (56), 60, 64, (68), 72, (76), 80, (88), 90, 96; And for the fifth's active jazz scale 48, (49&1/2), 54, (58&1/2), 60, (63), 64, 72, (76), 81, (85), 90, 96.

Except for moving the diatonic scale's fourth to keep the jazz seventh in tonal order for the fifth's active jazz scale, the diatonic scale is the same as the non-jazz version of the diatonic scale. Since this could affect the musician's performance, it might be reasonable to have more than one form of diatonic jazz scale. For instance the fifth's active scale without the jazz seventh would be 48, (49 1/2), 54, (58 1/2), 60, 64, (68), 72, (76), 81, (85), 90, 96. And, with the jazz seventh it would be 48, (49 1/2), 54, (58 1/2), 60, 63, (64), 72, (76), 81, (85), 90, 96. An extra foot pedal could be added to “sustain” the active fourth with the jazz seventh version so that the diatonic scale is only modified by the musician intentionally.

### BRIEF SUMMARY OF THE INVENTION

This invention has two similar parts with two very different sets of controls. The first part as seen in FIG. 1 is a modified MIDI Sound Module 1 for use in a Digital Audio Workstation (DAW) 2. The modifications of the DAW Sound Module for this invention allow alternate active versions of a scale that use different pitches for specified notes during different parts of a musical piece. The modified DAW Sound Module can be controlled by the sound engineer or producer from the DAW and/or the modified DAW Sound Module can be controlled by a musician playing a MIDI Keyboard in the studio with the same Foot Pedal controls 7 used for the Stage Keyboard.

This invention's second part as seen in FIG. 4 applies to the sound module 46 built into a Stage Keyboard. The modifications presented in this invention for the second part controls the use of pitches for active scales in the same way as the first part. The second part also includes controls to be used by the musician playing the Keyboard. These are the same Foot Pedal controls 49 used by the musician playing a MIDI Keyboard in a studio.

### BRIEF DESCRIPTION OF THE DRAWINGS

FIG. 1 displays a Digital Audio Workstation with a MIDI Sound Module and a Pitch Generator with reference numbers 1 to 16.

FIG. 2 displays a comparison between the Diatonic and Jazz scales in the upper row and the Well-Tempered Chromatic scale in the lower row.

FIG. 3 displays a Tonnetz Chart of the Diatonic C Scale showing the positions of the alternate D and A notes with reference numbers 31 to 32.

FIG. 4 displays a Stage Keyboard with Sound Module with reference numbers 40 to 49.

FIG. 5 displays a Tonnetz Chart for Chord Recognition with reference numbers 50 to 52.

FIG. 6 displays the recommended organization and color of the keyboard Foot Pedal Controls with reference numbers 61 to 65.

### DETAILED DESCRIPTION OF THE INVENTION

### The Sound Module and Pitch Generator

The first preferred embodiment of this invention is as an electronic musical component, herein called the Sound Module 1. A MIDI Sound Module is typically used by a recording engineer or producer as part of a Digital Audio Workstation (DAW) 2 in a studio. The DAW already has displays and controls 3 that the sound engineer or the producer can use to select the scales 4 and various sounds that he wants to use from the memory 5 of the DAW. The Sound Module also has a pitch generator 15 in it to generate the sounds for each keyboard key 6 pressed. The pitch generator actually generates the audio sound signal to be sent to external speakers 13 via an audio cable 12. The pitch generator also has an expanded array of pitches 9, 10 & 11 that specify the pitch to be generated for each keyboard key 6 pressed. This embodiment not only has an array for the basic scale 9 but also an array for each of the other active scales 10 & 11. Each active scale of this embodiment has a complete array for each active scale which includes the pitches for the modified scale notes and all the other pitches of the basic scale. All of the pitches of every active scale 9, 10 & 11 are extended to every octave so all of the keyboard keys 6 are covered.

### The Active Scale Selector and Active Scales

The pitch generator for the preferred embodiment has a new variable called the Active Scale Selector 8 which designates the active scale to be used: vi/I 9, ii/IV 11 or iii/V 10. When the major tonic for a new basic scale is specified, by default the active scale selector 8 is set to designate that basic scale's array 9. When a signal to reset the active scale is received and the new active chord is recognized (as described in paragraph [0057]), the active scale selector 8 will be set to designate the new active scale's array. That allows all the notes played on the keyboard by the musician to sound harmonious for any chord.

The Active Scale associated the major Fourth chord 11 has one note changed from the basic diatonic scale. That note is the Second of the diatonic scale 31 and it is lowered one syntonic comma when the Fourth chord or its relative minor chord is active. The Active Scale associated the major Fifth chord 10 has one note changed from the basic diatonic scale. That note is the Sixth of the diatonic scale 32 and it is raised one syntonic comma when the Fifth chord or its relative minor chord is active.

### The DAW Controls for MIDI

The DAW has multiple inputs that the sound engineer or producer can designate to trigger a MIDI signal to request a new active scale designation.

### The New Pedals for MIDI Keyboard or the Stage Keyboard

The MIDI Keyboard for this invention should have an additional set of foot pedal controls 7 & 62 to initiate the selection of a new Basic Scale using the Green Pedal 63 or to signal a request for new Active Scale designation using the Red Pedal 64 or to switch the use of the Jazz Scale Notes using the Blue Pedal 65. The same new set of pedals 62 is available for the Stage Keyboard controls 49.

The Green Pedal 63 initiates the selection of a new Basic Scale. When the musician presses on the Green Pedal a signal is triggered to set a new basic scale. As soon as a keyboard key 6 is pressed that represents the tonic of the relative major scale associated with the chosen basic key, the new basic scale is registered in the Sound Module. In the preferred embodiment, if no music is being played and the Green Pedal is pressed and released followed by pressing the chosen major tonic keyboard key, the chosen note will be played audibly. If no music is being played and the Green Pedal is pressed and held down while the chosen major tonic keyboard key is pressed, that chosen tonic will not be played audibly. If music is being played when the Green Pedal is pressed the note played will be played audibly.

The Red Pedal 64 in many ways is the opposite of the sustain pedal although it provides no sustain effect. The sustain pedal is usually held down for a phrase in a musical piece as long as the chord does not change. When the chord changes, the sustain pedal is briefly released and reapplied until the next chord change. The MIDI Keyboard will send two signals to the MIDI Sound Module: one when the sustain pedal is pressed, and one when the sustain pedal is released. The Red Pedal 64 acts in a similar way. It also sends a signal when it is pressed and when it is released. The sustain pedal us pressed and held just as the chord changes so that the sound of the chord can be as full as possible as the new chord is played. In the preferred embodiment a signal to request a new active scale designation is associated with the signal sent when the sustain pedal is pressed. The Red Pedal also sends a signal when pressed and a signal when released. But it is the release of the Red Pedal that sends the signal which triggers the calculation (as described in paragraph [0057]) to recognize the new active chord and reset the active key. So the Red Pedal is pressed when the sustain pedal is released and released when the sustain pedal is pressed. The Red Pedal can be used to request a new active scale designation even if the sustain pedal is not being used.

The Blue Pedal 65 switches the state of the extra Jazz Scale notes. Normally the Diatonic Scale in any of its active forms uses seven of the twelve notes in an octave. The other five notes are given reasonable diatonic pitches, but they are not usually considered part of the Diatonic Scale. In the preferred embodiment these other five notes are replaced with the Jazz Scale notes when the Blue Pedal is pressed and released. If the Jazz Scale notes are already set when the Blue Pedal is pressed, the Jazz Scale notes are cleared and reasonable diatonic pitches are reset. If the Red and Blue Pedals are pressed together, when released the jazz notes for the active scales are set.

### The Stage Keyboard

The second preferred embodiment of this invention is as a Stage Keyboard. Unlike the MIDI Keyboard, the Stage Keyboard has the Sound Module 41 built in. All of the parts that make this invention effective for the first embodiment are present in the second:

| DAW | Stage Keyboard | Part |
|---|---|---|
| 1 | 41 | Sound Module |
| 15 | 42 | Pitch Generator |
| 8 | 43 | Active Scale Selector Variable |
| 9 | 44 | Basic (Tonic) Scale |
| 10 | 45 | Active Fifth Scale |
| 11 | 46 | Active Fourth Scale |
| 7 | 49 | Control Pedals |

And the Chord Recognition is performed the same way. Unlike the first embodiment, everything is present in one complete keyboard.

### The Chord Recognition Feature

The Chord Recognition capability acts when a signal to request a new active scale is received from the Sustain Pedal or the new Red Pedal 63. After an active scale reset signal is received, the chord supporting this new section of music must be identified. This is done by using two or three of the most bass notes being played. The most bass notes are used because they are usually chord notes rather than passing melody notes. To select the three most bass notes, any note more than an octave and a sixth above the most bass note played should be ignored. The octave of the bass notes should not be considered as different notes. If a lower bass note is played the cut-off should also be moved. The notes being held down when the signal to request a new active scale is received should be used to recognize the chord. As soon as notes are available below the cut-off, these notes should be associated with the chord diagonals 51. If two or three bass notes 52 trigger two different chord diagonals the chord they form 50 will be between those chord diagonals. If all three bass notes are on the same chord diagonal, this specifies the chords to the left of the chord diagonal. When the three bass notes share the 6-1 diagonal and the 3-5 diagonal, they designate that the Tonic scale (I/vi) as the active scale 9. When the three bass notes share the 2-4 diagonal and the 6-1 diagonal, they designate the Fourth (IV/ii) as the active scale 11. When the three bass notes share the 3-5 diagonal and the (7)-2-4 diagonal together or all three bass notes are on the (7)-2-4 diagonal, they designate the Fifth (V/iii/V⁷) as the active scale 10. As soon as the active scale is recognized the Active Scale Selector 8 should be set.

### DETAILED DESCRIPTION OF THE DIAGRAMS

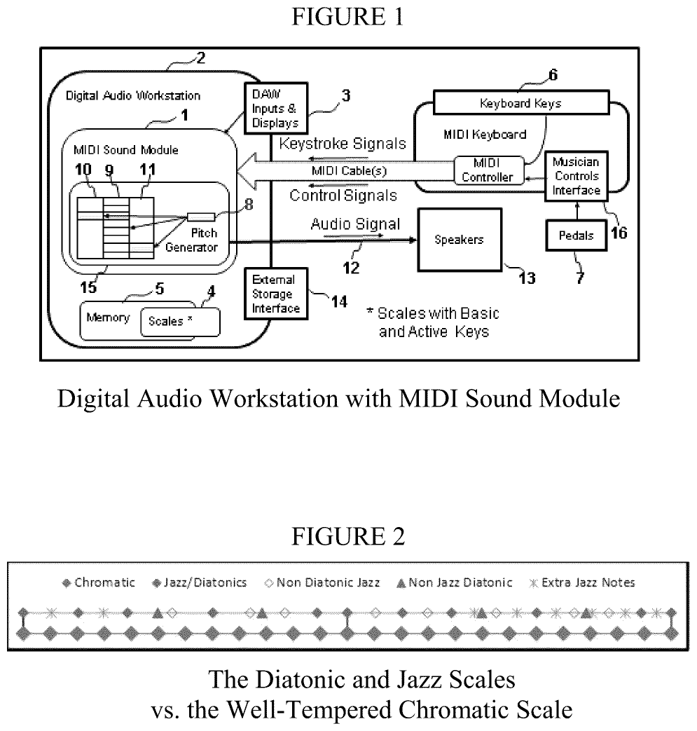

FIG. 1 displays a Digital Audio Workstation with MIDI Sound Module. This figure serves as the figure used for describing the primary embodiment of the invention for claims 1-6. This figure contains numbered components:
1 The MIDI Sound Module,
2 The Digital Audio Workstation (DAW),
3 The DAW Displays and Input Controls,
4 Plurality of Scales with Basic and Active Scales
5 The Memory for the Sound Module and DAW
6 MIDI Keyboard Keys
7 MIDI Keyboard Foot Pedals
8 Active Scale Selector Variable
9 Basic Scale's Tonic Pitch Specification Array
10 The Fifth's Active Scale Pitch Specification Array
11 The Fourth's Active Scale Pitch Specification Array
12 Audio Connector Cable
13 Speakers
14 External Storage Socket
15 Pitch Generator
16 MIDI Keyboard Controls Interface

Please be aware that components 9, 10 and 11 of FIG. 1 which represent arrays of pitches used by the Pitch Generator 15 cover as many octaves as the Pitch Generator needs to generate pitches for all the keyboard keys 6.

FIG. 2 illustrates two rows of logarithmically spaced pitches that represent musical scales. The lower row is a two-octave well-tempered chromatic scale. These pitches correspond to the pitches produced by the keys on a traditional piano keyboard. The upper row contains both a two octave diatonic scale represented by solid diamonds and solid triangles and a jazz scale represented by solid diamonds and hollow diamonds. These jazz scale notes all fall on pitches that are exact (whole number) multiples of a fundamental pitch which is also the Tonic. The asterisks that appear in the left octave (8 to 16) are fractional multiples of the fundamental pitch (8&1/2, 9&1/2), but in the right octave (16 to 32) they are exact multiples of the fundamental pitch (17, 19). The asterisks that appear in the right octave represent Jazz notes that are exact multiples of the fundamental pitch (21, 23, 25, 27, 29, 31) but are rarely used in musical pieces. So all the notes represented on the top line are on the harmonics 8, (8&1/2), 9, (9&1/2), 10, (10&2/3), 11, 12, 13, (13&1/3), 14, 15, 16, 17, 18, 19, 20, 21, (21&1/3), 22, 23, 24, 25, 26, (26&2/3), 27, 28, 29, 30, 31, 32

For FIG. 2 the following information augments the FIG. 2 LEGEND.

| SYMBOL | TYPE | UPPER ROW HARMONICS |
|---|---|---|
| ♦ | Diatonic Notes | 8, 9, 10, 12, 15, 16, 18, 20, 24, 30, 32 |
| ⋄ | Jazz Notes | 11, 13, 14, 17, 19, 22, 26, 28 |
| ▴ | Non Jazz Diatonic | 10&2/3, 13&1/3, 21&1/3, 26&2/3 |
| * | Extra Jazz Notes | 8&1/2, 9&1/2, 21, 23, 25, 27, 29, 31 |

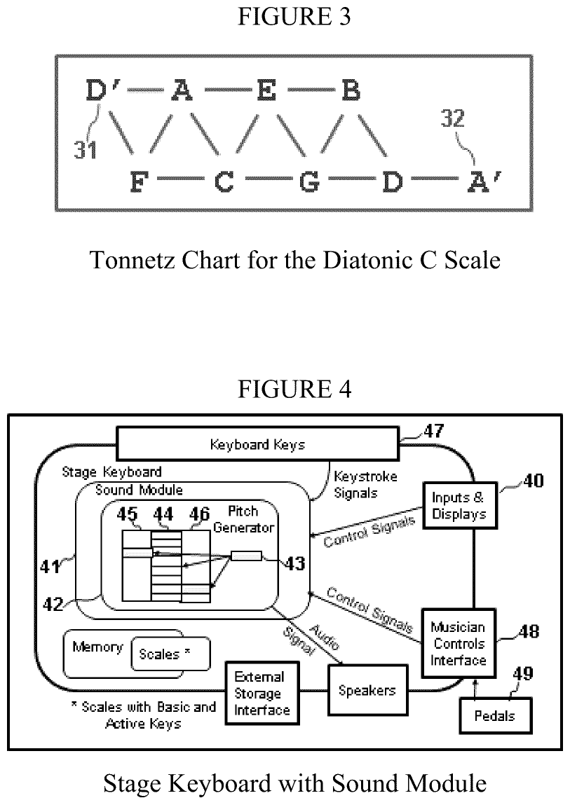

FIG. 3 displays a Tonnetz Chart of the Diatonic C Scale. The horizontal lines (e.g. D-A) represent an interval of a fifth. The left slanting diagonal lines (e.g. D-F) represent an interval of a minor third. The right slanting diagonal lines (e.g. F-A) represent an interval of a major third. The two notes marked with an apostrophe D′ and A′ are part of the Diatonic C scale's two active scales. The D′ note is associated with the Fourth chord and its relative minor. The A′ note is associated with the Fifth chord and its relative minor.

FIG. 4 displays a Stage Keyboard with Sound Module. This figure serves as the figure used for describing the primary embodiment of the invention for claims 7-13.

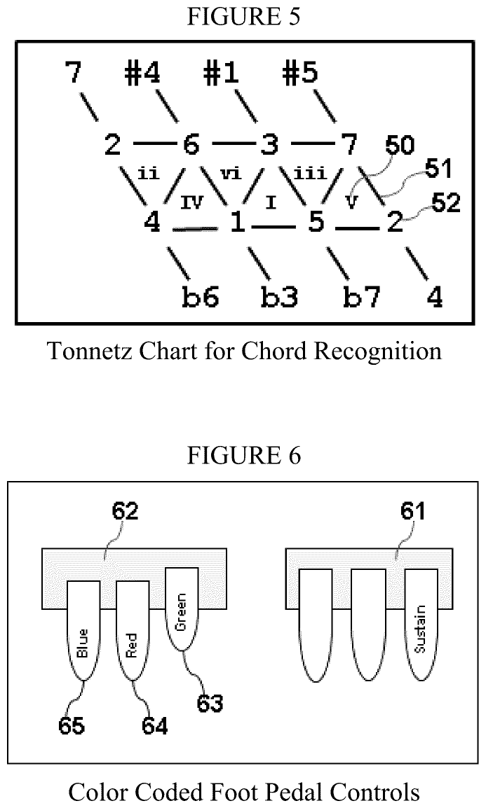

FIG. 5 displays a Tonnetz Chart for Chord Recognition. This figure serves the detailed description of the embodiment of claim 4-5. The numbers 52 correspond to the notes of a scale, and the Roman numerals 50 represent the chords made by the notes that make up the triangle they are in. The upper case Roman numerals represent major chords and the lower case Roman numerals represent minor chords. The scale notes are grouped into the left leaning chord diagonals 51. Several of the notes in the bottom row are prefaced with a lowercase letter ‘b’, this represents a flat. (i.e. a half step below the specified scale note.) Similarly several notes in the top row are prefaced with a ‘#’, this represents a sharp. (i.e. a half step above the specified scale note.) Note that #5 (in the right chord diagonal) and b6 (in the left chord diagonal) are the same note. That means that all the notes in the right most chord diagonal and the left most chord diagonal are actually the same chord diagonal.

FIG. 6 displays the recommended organization and color of the keyboard pedals that are available for use by the musician. The three pedals on the right 61 are the standard piano pedals. The ones on the left 62 are the new pedals associated with this invention. They are used for selecting and controlling the basic and active scales. From right to left they are the Green Pedal 63 for selecting the basic scale at the start of a piece or at a key change within the piece. The Red Pedal 64 is used to trigger a change of the active scale. The Red Pedal is essentially the opposite of the standard sustain pedal. The Blue Pedal 65 is for setting the Jazz Scale features.

### NOTICES

The term “key” has two different meanings in the following claims. When prefaced by the word “keyboard”, “key” refers to a physical key like the black and white keys on a piano keyboard; When prefaced by the word “basic” or the word “active”, “key” refers to the name of a musical scale.

The “fundamental” is the pitch on which the harmonics are based. The “fundamental” is not necessarily the same as the “tonic”.

Within these claims “plurality” means “one or more”. Therefore, the following disclaimer is added to clarify “the plurality of scales” of claim 1.

### Disclaimer

This patent disclaims any electronic component of claim 1 wherein the plurality of types of musicale scales is composed only of other scales not having basic and active scales.

1. An electronic component comprising a means for selecting a type of scale from a plurality of types of musical scales comprising one or more of the following scale types: a diatonic major scale with basic and active scales, a diatonic minor scale with basic and active scales, a semi-diatonic major scale with basic and active scales, a semi-diatonic minor scale with basic and active scales, a jazz scale with basic and active scales or other scales.

2. An electronic component of claim 1 further comprising a means for designating a basic key for said selected type of musical scale.

3. An electronic component of claim 1 further comprising a means for designating an active scale from said basic scale.

4. An electronic component of claim 3 wherein the means for designating the active scale further comprising an active scale selection process.

5. An electronic component of claim 4 wherein the active scale selection process further comprising a method for recognizing the chord played.

6. An electronic component of claim 1 further comprising a means for producing musical sounds for the pitches associated with the notes of said selected scale.

7. An electronic musical instrument comprising the electronic component of claim 1 and a means to play a plurality of notes of said selected scale.

8. An electronic musical instrument of claim 7 wherein the means to play said plurality of notes further comprising a keyboard with individual keyboard keys for each note of said scale.

9. An electronic musical instrument of claim 8 wherein the means to play said plurality of notes further comprising a means for producing musical sounds for the individual pitches associated with the said notes.

10. An electronic musical instrument of claim 9 wherein the means to select the said scale type further comprising a control panel component.

11. An electronic musical instrument of claim 10 wherein the means to select a basic key further comprising a method to specify said basic key by playing one keyboard key.

12. An electronic musical instrument of claim 11 wherein the means to select the active scale further comprising an active scale selection process.

13. An electronic musical instrument of claim 12 wherein the active scale selection process further comprising a signal from a foot pedal activation.
